(19) United States
(12) Patent Application Publication
(10) Pub. No.: US 2014/0298993 A1
(43) Pub. Date: Oct. 9, 2014

(54) HYDROGEN SEPARATION MEMBRANE MODULE WHICH HAVE MIXING PART

(71) Applicant: KOREA INSTITUTE OF ENERGY RESEARCH, Daejeon (KR)

(72) Inventors: Shin-Kun Ryi, Daejeon (KR); Jong-Soo Park, Daejeon (KR); Kyung-Ran Hwang, Daejeon (KR); Chun-Boo Lee, Daejeon (KR); Sung-Wook Lee, Daejeon (KR)

(21) Appl. No.: 14/354,350

(22) PCT Filed: Oct. 23, 2012
(86) PCT No.: PCT/KR2012/008718

§ 371 Date: Apr. 25, 2014

(30) Foreign Application Priority Data
Oct. 31, 2011 (KR) 10-2011-0112092

(51) Int. Cl. B01D 53/22

(52) U.S. Cl. CPC B01D 53/228
USPC 96/7; 96/4

(57) ABSTRACT

Provided is a hydrogen separation membrane module, and more particularly, a hydrogen separation membrane module having a mixing part capable of increasing hydrogen purification efficiency by maximizing a mixing effect and a dispersion effect of a mixture gas supplied to the hydrogen separation membrane using the mixing part provided with a microchannel to supply the mixture gas to the hydrogen separation membrane.

### TECHNICAL FIELD

The present invention relates to a hydrogen separation membrane module, and more particularly, to a hydrogen separation membrane module having a mixing part capable of increasing hydrogen purification efficiency by maximizing a mixing effect and a dispersion effect of a mixture gas supplied to the hydrogen separation membrane using the mixing part provided with a microchannel to supply the mixture gas to the hydrogen separation membrane.

### BACKGROUND ART

A hydrogen purification module means an apparatus for purifying a mixture gas in which hydrogen is mixed or reformed low-purity hydrogen into high-purity hydrogen. Hydrogen has been widely used in semiconductor and fine chemistry industry fields and recently, as hydrogen is used as fuel gas of a fuel cell, a need to produce high-purity hydrogen has been increased.

As a method for producing hydrogen, there is a method for producing synthesis gas of carbon monoxide and hydrogen mixture by, for example, coal gasification (reaction formula 1) and performing water-gas shift reaction (reaction formula 2) of carbon monoxide to reduce a carbon monoxide concentration, thereby increasing a hydrogen concentration [Reference: J. Kopyscinski, T. J. Schildhauer, S. M. A. Boillaz, Production of synthetic natural gas (SNG) from coal and dry biomass-A technology review from 1950 to 2009, Fuel 89 (2010) 1763]. Hydrogen/carbon dioxide may be produced at a ratio of 60/40 by the method.

CₓH_{y}+xH₂O→xCO +(x+y/2)H₂, ΔH₂₉₅^{o}>0 kJ/mo [Reaction Formula 1]

CO+H₂O→CO₂+H₂, ΔH₂₉₅^{o}=+41 kJ/mo [Reaction Formula 2]

To supply hydrogen to a system requiring high-purity hydrogen and treat carbon dioxide, an additional hydrogen purification process or a carbon dioxide purification process is required. As the representative hydrogen purification method, a purification process using pressure swing adsorption (PSA), a getter process, a cryogenic, and a process using a membrane have been known.

The process of purifying hydrogen using a membrane has an advantage in a continuous operation, heat efficiency, a compact configuration of a system, and the like. A palladium-based dense membrane has been known as the most efficient hydrogen separation membrane for achieving the above advantages, and a composition thereof mainly includes Pd or a palladium alloy such as Pd—Cu and Pd—Ag.

For a configuration of a hydrogen purification and separation membrane reactor using a separation membrane, a module configuration of a separation membrane is required. Representatively, U.S. Pat. No. 5,498,278 discloses a hydrogen purification module which includes an inlet, a hydrogen outlet, a raffinate outlet, and a hydrogen separation membrane. The hydrogen separation membrane includes a coating metal layer through which hydrogen passes, a support matrix, and a porous layer interposed therebetween. In configuring the hydrogen purification module having a plate-and-frame form or a shell-and-tube form, including the hydrogen separation membrane, a unit cell is configured by a diffusion bonding.

However, the hydrogen purification module having the above form has reduced separation membrane performance and lifespan due to the diffusion bonding at high temperature or a thermal diffusion between the separation membrane and the module during a high temperature operation of 450 to 550° C. Further, the hydrogen purification module has the complicated structure, the increased weight, and the reduced heat efficiency due to housing.

Korean Patent No. 10-0980692 discloses a hydrogen purification unit cell, a method for manufacturing the same, and a hydrogen purification module including the same. The hydrogen purification unit cell has a hollow part mounted therein and one side or both sides thereof are provided with moving holes, protrusion bonding parts, bodies with which side hydrogen discharge tubes are provided, diffusion bonded hydrogen separation membranes provided with bonding enhancement layers which are formed on the protrusion bonding parts, and porous support members. The plurality of hydrogen purification unit cells are coupled with the housing in which a mixture gas supply part and a filtered gas discharge part are provided so as to prevent the separation membrane from being damaged due to the contact between oxygen and the separation membrane unit cells, thereby configuring the hydrogen purification module.

However, Korean Patent No. 10-0980692 discloses the configuration of the unit cell due to the diffusion bonding and the method for mounting a plurality of unit cells in a housing and therefore the separation membrane performance and lifespan are reduced due to the diffusion between the separation membrane component and the unit cell component when the separation membrane is bonded to the unit cell. Further, the module configuration and procedure are complicated due to the outside housing configuration.

Therefore, the hydrogen purification module according to the related art has the unit cell configuration due to the diffusion bonding and therefore the separation membrane performance and lifespan are reduced due to the thermal diffusion between the separation membrane and the unit cell. Further, the structure is complicated and is difficult to be manufactured in a compact form due to the unit cell and the housing configuration.

Therefore, the present inventors propose “Module Configuration of Hydrogen Separation Membrane Module for the Reduce Of Concentration Polarization” in Korea Patent Application No. 10-2011-0051991. As illustrated in FIG. 1, the hydrogen separation membrane module is configured to include a lower flange part 40 which has a seating groove 41 disposed therein, is provided with a plurality of support protrusions 44 disposed under the seating groove 41, and is provided with at least one hydrogen through hole 45 for discharging hydrogen to the outside; a porous support 20 seated in a space defined by the seating groove 41 and the support protrusions 44 disposed on the lower flange 40; a hydrogen separation membrane 10 which is supported by the porous support 20; and an upper flange 30 which is coupled with the lower flange 40 and is provided with at least one through hole 35 in a length direction, in which an internal seal 50 is densely disposed between the hydrogen separation membrane 10 and the upper flange 30 and a mutual space distance T in a hydrogen separation space 70 defined by the upper flange 30 and the hydrogen separation membrane 10 is set to be 0.01 to 20 mm.

As described above, since the hydrogen separation membrane module has more excellent hydrogen separation efficiency than the previous hydrogen separation module according to the related art but the mutual space distance in the hydrogen separation space is still present, a hydrogen concentration of a mixture gas is reduced as being far away from a supply pipe through which the mixture gas is supplied to the hydrogen separation space, such that the mixture gas may not be uniformly supplied to the hydrogen separation membrane.

Further, when the hydrogen separation membrane is configured in a foil form, the configuration to support the separation membrane is not yet present, and therefore a wrinkle may occur in the hydrogen separation membrane over time and when the occurrence of wrinkle is continued, the separation membrane may be damaged.

Therefore, a need exists for a technology of configuring the hydrogen separation space having at least mutual space distance at which the pressure drop does not occur and more effectively supplying the mixture gas to the hydrogen separation membrane than the related art.

### DISCLOSURE

### Technical Problem

An exemplary embodiment of the present invention is directed to providing a hydrogen separation membrane module having a mixing part, in which a plate-shaped mixing part having a similar size to a hydrogen separation membrane is provided with a microchannel and the mixing part is disposed on a hydrogen separation space to mix and disperse mixture gas or low-purity hydrogen gas supplied from a supply pipe while the mixture gas or the low-purity hydrogen gas passes through the mixing part.

### Technical Solution

In one general aspect, there is provided a hydrogen separation membrane module having a mixing part, including: a housing having a hydrogen separation space disposed therein; a supply part communicating with one surface of the hydrogen separation space; a discharge part communicating with the other surface of the hydrogen separation space; a hydrogen separation membrane disposed between the supply part and the discharge part in the hydrogen separation space; and a mixing part having at least one microchannel disposed therein and disposed between an inlet and the hydrogen separation membrane.

The mixture part may include first groove parts disposed on an upper surface thereof to be depressed at a predetermined interval along a length direction and second groove parts disposed on a lower surface thereof to be depressed at a predetermined interval along a length direction, and the first groove part and the second groove part may be formed to have a predetermined angle and overlapping portions between the first groove parts and the second groove parts penetrate through each other to form a microchannel.

The mixture part may include a first membrane provided with a plurality of first bars, being spaced apart from each other at a predetermined distance; and a second membrane disposed under the first membrane and provided with a plurality of second bars, being spaced apart from each other at a predetermined distance, and the second bars are coupled or integrally formed having a predetermined slope with respect to the first bar, and the microchannel may be formed in a spaced space between the first bar and the second bar.

The mixture part may be made of ceramic or a metal material which is not alloyed with the hydrogen separation membrane.

An outer surface of the mixing part may be provided with an oxide layer.

When the mixing part is made of the metal material, the oxide layer may be formed by coating the mixing part with any one selected from aluminum (Al), zirconium (Zr), silicon (Si), and titanium (Ti) oxides. When the mixing part is made of the aluminum material, the oxide layer may be formed by oxidizing the mixing part.

An internal seal may be densely disposed between the hydrogen separation membrane and the housing and a diffusion suppression layer may be disposed between the hydrogen separation membrane and the internal seal.

An internal seal may be densely disposed between the hydrogen separation membrane and the housing and an outer surface of the internal seal may be provided with a real diffusion suppression layer configured to enclose the internal seal.

The housing, the mixing part, and the hydrogen separation membrane may be a tube type in which both ends are opened and an inside of the housing may be sequentially stacked with the mixing part and the hydrogen separation membrane.

### Advantageous Effects

According to the hydrogen separation membrane module having a mixing part according to the exemplary embodiment of the present invention, the mixture gas or the low-purity hydrogen gas passing through the mixing part is uniformly supplied to the hydrogen separation membrane and therefore the hydrogen purification efficiency is more increased than that of the exiting hydrogen separation membrane module. Further, when the hydrogen separation membrane is configured in the foil form, the hydrogen separation membrane is supported by the mixing part and therefore the deformation of the hydrogen separation membrane may be prevented.

### DESCRIPTION OF DRAWINGS

The above and other objects, features and advantages of the present invention will become apparent from the following description of preferred embodiments given in conjunction with the accompanying drawings, in which:

FIG. 1 is a cross sectional view of a hydrogen separation membrane module according to the related art;

FIG. 2 is an exploded perspective view of a hydrogen separation membrane module according to a first exemplary embodiment of the present invention;

FIG. 3 is a perspective view of a mixing part according to a 1-1-th exemplary embodiment of the present invention;

FIG. 4 is cross-sectional views taken (A) along the line AA′ of FIG. 3 and (B) along the line BB′ of FIG. 3;

FIG. 5 is an exploded perspective view of a mixing part according to a 1-2-th exemplary embodiment of the present invention;

FIG. 6 is a coupled cross-sectional view of a hydrogen separation membrane module illustrated in FIG. 2;

FIG. 7 is a coupled cross-sectional view of a hydrogen separation membrane module illustrated in FIG. 2 according to another exemplary embodiment of the present invention;

FIG. 8 is a rear view of an upper flange which is applied to the hydrogen separation membrane module according to the first exemplary embodiment of the present invention;

FIG. 9 is a front view of a lower flange which is applied to the hydrogen separation membrane module according to the first exemplary embodiment of the present invention;

FIG. 10 is a cross-sectional view of an operation state of the hydrogen separation membrane module according to the first exemplary embodiment of the present invention;

FIG. 11 is a longitudinal cross-sectional view of a hydrogen separation membrane module according to a second exemplary embodiment of the present invention; and

FIG. 12 is a perspective view of an operation state of the hydrogen separation membrane module according to the second exemplary embodiment of the present invention.

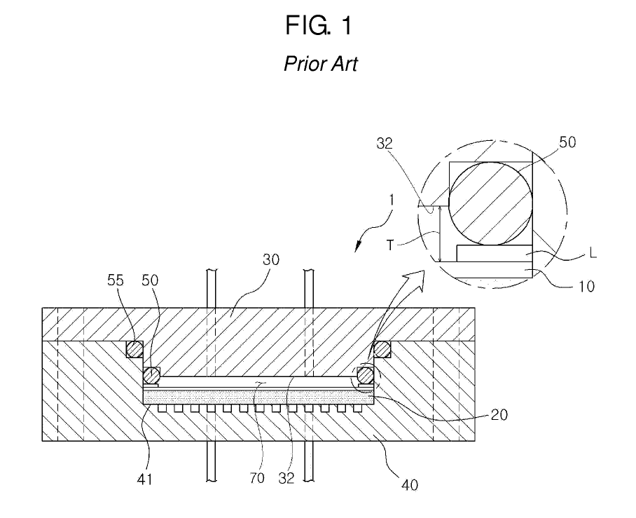

### BEST MODE

Hereinafter, exemplary embodiments of the present invention will be described in more detail with reference to the accompanying drawings. However, in describing exemplary embodiments of the present invention, well-known functions or constructions will not be described in detail since they may unnecessarily obscure the understanding of the present invention.

### Embodiment 1

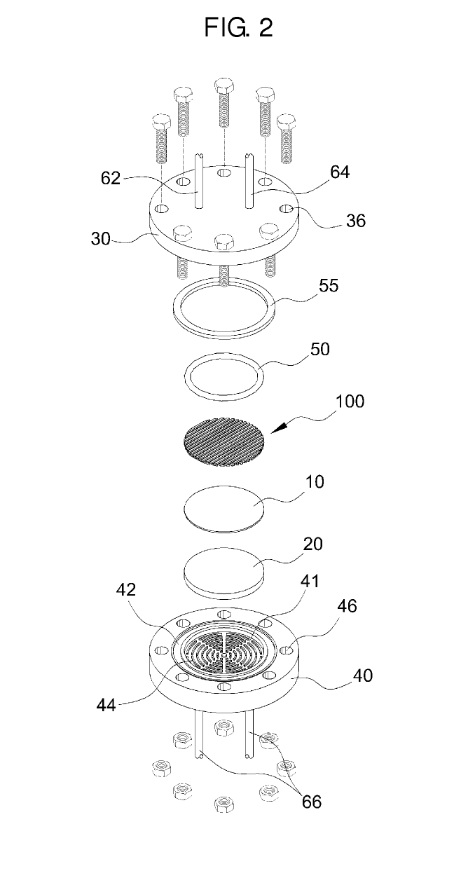

Referring to FIGS. 2 to 9, a hydrogen separation membrane module 1 according to a first exemplary embodiment of the present invention includes housings 30 and 40 including a lower flange 40 and an upper flange 30, the lower flange 40 having a seating groove 41 disposed at an inside thereof, porous supports 20 sequentially seated in the seating groove 41 of the lower flange 40, and a hydrogen separation membrane 10 supported by the porous support 20 and selectively permeating hydrogen, and the upper flange 30 coupled with the lower flange 40.

Further, the hydrogen separation membrane module 1 according to the exemplary embodiment of the present invention includes an internal seal 50 and an external seal 55 for gas leakage interruption.

The internal seal 50 is preferably configured of a metal ring, in particular, a metallic O-ring or a metallic C-ring which perforates in a central direction of the hydrogen separation membrane 10. The metal ring is made of metal materials such as nickel and iron. To more reinforce a sealing force, it is preferable to coat an outside with gold, silver, nickel and the like. When the internal seal 50 is disposed on the hydrogen separation membrane 10, the internal seal 50 contacts an inner side of the upper flange 40. This is to improve the sealing ability with the upper flange 30.

The external seal 55 may be configured of a metal ring or a graphite ring which may be operated at 550° C. or more. The external seal 55 may use any form of metallic ring which is used in the internal seal 50. Further, in addition to the metal seal, a graphite ring which may be operated at high temperature may be used. According to the exemplary embodiment of the present invention, a metallic ring having a circular cross section is used, but those skilled in the art may consider various forms of metallic ring.

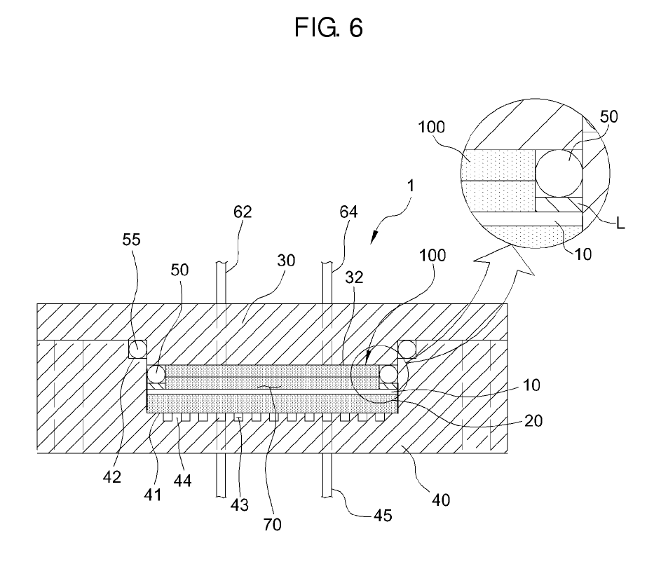

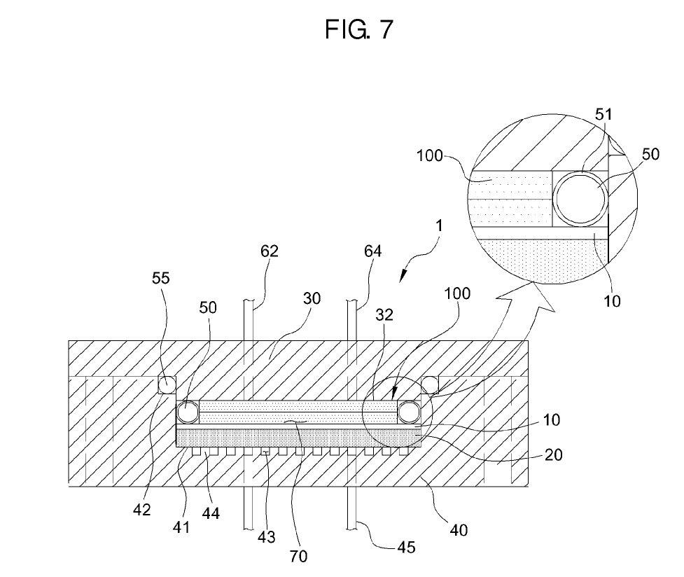

Further, in the hydrogen separation membrane module 1 according to one exemplary embodiment of the present invention, as illustrated in FIGS. 6 and 7, a hydrogen separation space 70 which is a space in which hydrogen is actually separated is provided as a space defined by the upper flange 30, the hydrogen separation membrane 10, and the internal seal 50.

In this case, the present invention has the following configuration to uniformly supply mixture gas supplied to the hydrogen separation space 70 to the hydrogen separation membrane 10.

The hydrogen separation space 70 is provided with a mixing part 100. The mixing part 100 may be configured of a circular plate shape having the same size as the hydrogen separation space 70. Although the mixing part 100 is illustrated in a circular shape in the drawings, it is apparent that various shapes may be applied according to the form of the hydrogen separation membrane module 1. However, an upper surface of the mixing part 100 is configured to contact an upper portion of the hydrogen separation space 70 and a lower surface thereof is configured to contact a lower portion of the hydrogen separation space 70. That is, a thickness of the mixing part 100 is configured to match a mutual space distance of the hydrogen separation space 70. The mixing part 100 may be provided with a microchannel 101 for mixing and dispersing the mixture gas and the detailed example of the mixing part 100 for forming the microchannel 101 will be described.

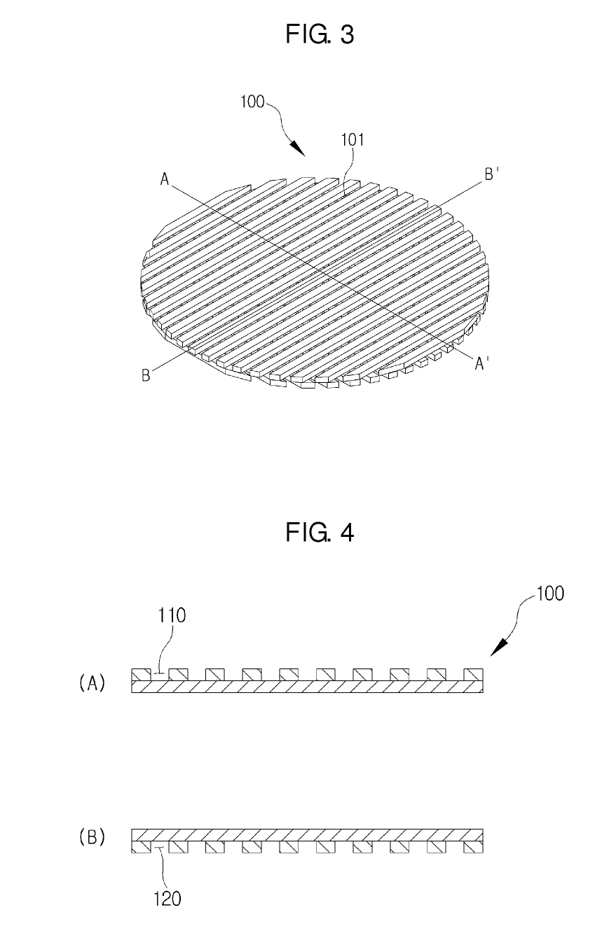

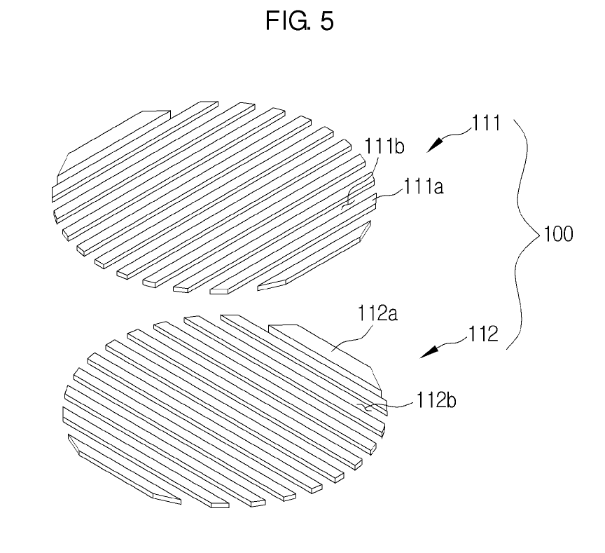

Referring to FIGS. 3 and 4, the mixing part 100 is configured to include a first groove part 110 and a second groove part 120. The first groove part 110 may be depressed on the upper surface of the mixing part 100 at a predetermine interval along a length direction. Further, the second groove part 120 may be depressed on the lower surface of the mixing part 100 at a predetermine interval along a length direction. In this case, the first groove part 110 and the second groove part 120 may be inclined to have a predetermined angle. Further, the first groove part 110 and the second groove part 120 may be formed to be depressed, having a predetermined depth so that overlapping portions between the first groove parts 110 and the second groove parts 120 penetrate through each other. That is, the portion at which the first groove part 110 and the second groove part 120 overlappingly penetrate through each other is provided with the microchannel 101.

Referring to FIG. 5 as another exemplary embodiment of the present invention for configuring the mixing part 100, the mixing part 100 may be configured by coupling a first membrane 111 and a second membrane 112. The first membrane 111 is configured so that a plurality of first bars 111a are spaced apart from each other at a predetermined distance to form a first channel 111b and the second membrane 112 is configured so that a plurality of second bars 112a are disposed under the first membrane 111 and are spaced apart from each other at predetermined distance to form a second channel 112b. In this case, the first bar 111a and the second bar 112a may be inclinedly coupled with each other to have a predetermined angle. Further, the first bar 111a and the second bar 112a may also be integrally coupled with each other. Therefore, the overlapping portion between the first channel 111b and the second channel 112b may be formed with the microchannel 101.

In this case, the mixing part 100 according to the exemplary embodiment of the present invention has the following characteristic configuration to suppress the separation membrane 10 from being lost due to the contact with the separation membrane 10. The contact portion between the mixing part 100 and the separation membrane 10, that is, the lower surface of the mixing part 100 may be coated with oxides and the detailed exemplary embodiment for coating the mixing part 100 with the oxides is as follows.

First, when the mixing part 100 is made of a metal material, the lower surface of the mixing part 100 may be coated with oxides such as aluminum (Al), zirconium (Zr), silicon (Si), and titanium (Ti).

Second, the mixing part 100 is made of aluminum metal and is oxidized to be converted into aluminum oxide metal.

Third, the mixing part 100 may be made of any one selected from oxides of aluminum (Al), zirconium (Zr), silicon (Si), and titanium (Ti).

Further, referring to FIG. 6, a diffusion suppress layer L is disposed between the internal seal 50 and the hydrogen separation membrane 10 in the hydrogen separation membrane module according to the exemplary embodiment of the present invention.

The diffusion suppress layer L is formed on a surface of the hydrogen separation membrane to be formed a portion contacting a sealing member. In this case, the diffusion suppression layer L includes a portion with which ceramic alone is coated or the ceramic and metal are coated simultaneously or in an arbitrary order. In this case, when the ceramic and the metal are used, as the metal used along with the ceramic, the structure material of the hydrogen separation membrane may be used. An example of a non-restrictive example of the material may include Pd, Cu, Ag, Au, Ru, Pt, and the like. The ceramic and the structure material of the hydrogen separation membrane, for example, Pd, Cu, Ag, Au, Ru, and Pt are co-sputtered and thus the mutual diffusion is suppressed.

Further, the diffusion suppression layer L according to the exemplary embodiment of the present invention performs the mutual suppression by disposing a surface-oxidized aluminum thin film (foil), which is obtained by oxidizing an outer surface of an aluminum thin film (foil), between the hydrogen separation membrane 10 and the seal 50. Further, although the present exemplary embodiment does not mention the external seal 55, those skilled in the art may be appreciated that like the internal seal 50, the present invention may be applied to the external seal 55.

FIG. 7 illustrates the hydrogen separation membrane module according to another exemplary embodiment of the present invention.

In the present exemplary embodiment, unlike the exemplary embodiment in which the diffusion suppression layer L is provided only on the specific contact surface, a real diffusion suppression layer 51 is provided by co-sputtering the ceramic or the structure material of the hydrogen separation membrane 10, for example, Pd, Cu, Ag, Au, Ru, and Pt on, for example, the whole outer surface of the internal seal 50 (for example, metallic O-ring) simultaneously or in an arbitrary order.

Further, although the present embodiment does not mention the external seal 55, those skilled in the art may be appreciated that like the internal seal 50, the present invention may be applied to the overall outer surface of the external seal 55.

The porous support 20 is made of porous metal or porous ceramic and supports the hydrogen separation membrane 10 to provide the easiness of the module configuration. The hydrogen separation membrane 10 is a known separation membrane and selectively permeates hydrogen. As the hydrogen separation membrane 10, palladium alone or a mixture or an alloy of one or two kinds metal components selected from a group consisting of palladium, Cu, Ag, Au, Ru, and Pt is used.

As described above, a material of the hydrogen separation membrane 10 is only one example and therefore is not limited thereto and it is apparent that any material which selectively permeates hydrogen may be applied.

The hydrogen separation membrane 10 may be a foil type or a type in which the hydrogen separation membrane 10 is coated on the porous support by coating methods, such as sputtering, electroless plating, electroplating, spray coating, and E-beam.

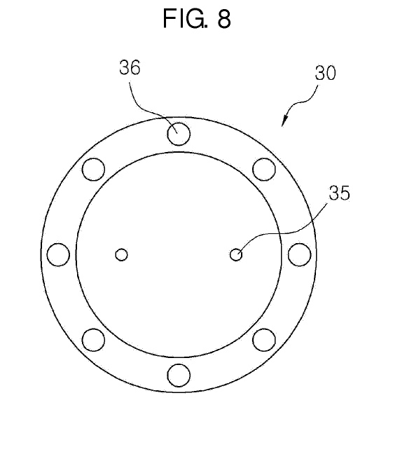

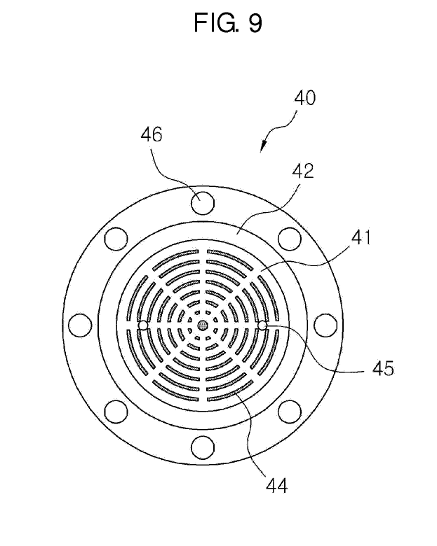

Referring to FIGS. 8 and 9, the lower flange 40 is provided with the plurality of support protrusions 44 for supporting the porous support 20 to the lower portion inside the seating groove 41. These support protrusions 44 support the hydrogen separation membrane 10 and the porous support 20 to prevent the separation membrane from being damaged due to the internal pressure. Further, the hydrogen discharge channel 43 formed by the space between these support protrusions 44 forms a path through which the purified hydrogen may move.

The seating groove 41 is provided with at least one hydrogen through hole 45 to discharge hydrogen to the outside. Further, as illustrated, the lower flange 40 is provided with the seating part 42 in which the external seal 55 at a contact surface with the upper flange 30 is seated.

The hydrogen separation membrane module is shown that an outer side of the upper flange 30 is coupled with a supply part 62 for supplying a mixture gas and a filtered gas discharge pipe 64 and an outer side of the lower flange 40 is coupled with a discharge part 66 for discharging the moving purified hydrogen, capturing the separated hydrogen. The discharge part 66 may be disposed at least one in response to the number of hydrogen through holes 45.

The upper flange 30 and the lower flange 40 may be tightly fixed by a method of inserting separate bolts are into fastening holes 36 and 46 disposed on each of the upper flange 30 and the lower flange 40 and fastening nuts in the bolts.

### Embodiment 2

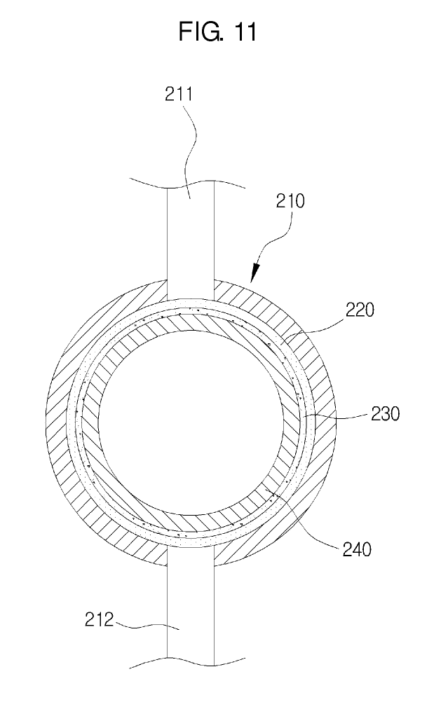

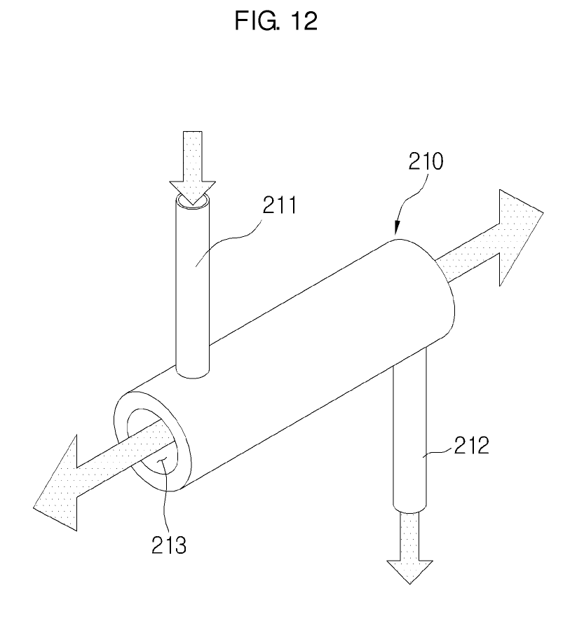

FIGS. 11 and 12 illustrate the hydrogen separation membrane module 2 according to the second exemplary embodiment of the present invention. A basic configuration of the hydrogen separation membrane module 2 according to the second exemplary embodiment of the present invention has the same configuration as the hydrogen separation membrane module 1 according to the first exemplary embodiment of the present invention, but the hydrogen separation membrane module 2 according to the second exemplary embodiment of the present invention is a different from the hydrogen separation membrane module 1 according to the first exemplary embodiment of the present invention in that a mixing part 220 and a hydrogen separation membrane 230 are formed in a tube type. Hereinafter, the detailed exemplary embodiment having the above configuration will be described below.

The hydrogen separation membrane module 2 according to the second exemplary embodiment of the present invention is configured to include a housing 210, a mixing part 220, a hydrogen separation membrane 230, and a support 240.

Both ends of the housing 210 are opened and have a cylindrical tube type. FIGS. 11 and 12 illustrate that both ends of the housing 210 are opened but the configuration that one end of the housing 210 is opened and the other end thereof is closed may be possible. FIGS. 11 and 12 illustrate that the housing 210 has a cylindrical shape, but it is apparent that if both ends of the housing 210 are opened, the housing may be formed in any shape. The housing 210 is coupled with a supply pipe 211 for supplying a mixture gas and a discharge pipe 212 for discharging the mixture gas. Therefore, the other end of the supply pipe 211 communicates with an inner space of the housing 210 and one end of the filtered gas discharge pipe 212 communicates with the inner space of the housing 210. In this case, the supply pipe 211 and the discharge pipe 212 are mounted on the housing 210 and may be disposed to be spaced apart from each other as far as possible. This is to increase the hydrogen purification efficiency.

The mixing part 220 may be inserted into an inner circumferential surface of the housing 210. The mixing part 220 has a tube type in which both ends are opened and an outer circumferential surface thereof is configured to contact an inner circumferential surface of the housing 210. The detailed configuration of the mixing part 220 is only the configuration in which the mixing part 100 according to the first exemplary embodiment of the present invention is changed, and therefore the description thereof will be omitted.

The hydrogen separation membrane 230 may be inserted into the inner circumferential surface of the mixing part 220. The hydrogen separation membrane 230 has a tube type in which both ends are opened and the outer circumferential surface thereof is configured to contact the inner circumferential surface of the mixing part 220. The hydrogen separation membrane 230 is only the configuration in which the known separation membrane is changed to the tube type and selectively permeates hydrogen. As the hydrogen separation membrane 230, palladium alone or a mixture or an alloy of one or two kinds metal components selected from a group consisting of palladium, Cu, Ag, Au, Ru, and Pt is used.

As described above, a material of the hydrogen separation membrane 10 is only one example and therefore is not limited thereto and it is apparent that any material which selectively permeates hydrogen may be applied.

The hydrogen separation membrane 230 may be a foil type or a type in which the hydrogen separation membrane 10 is coated on the porous support by coating methods, such as sputtering, electroless plating, electroplating, spray coating, and E-beam.

The support 240 may be inserted into the hydrogen separation membrane 230. The support 240 has a tube type in which both ends or one end is opened and an outer circumferential surface thereof is configured to contact an inner circumferential surface of the hydrogen separation membrane 230. In this case, the support 240 may be configured of a porous body to move the purified hydrogen from the hydrogen separation membrane 230 to an inside of the housing.

Hereinafter, the action of the exemplary embodiment of the present invention configured as described above will be described with reference to the accompanying drawings.

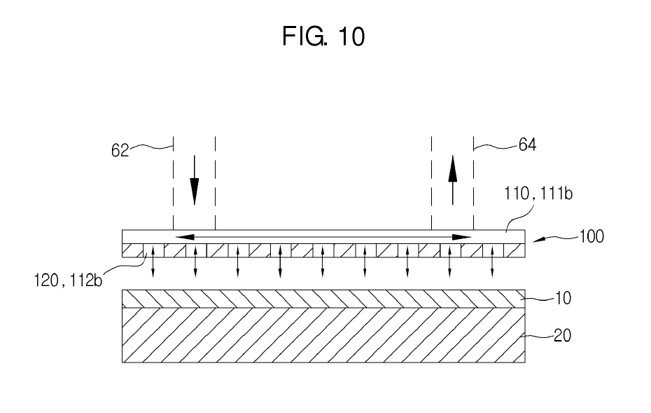

Referring to FIG. 10, in the hydrogen separation membrane module 1 according to the first exemplary embodiment of the present invention, the mixture gas supplied from a mixture gas supply pipe 62 is mixed and dispersed along the first groove part 110 or the first microchannel 111b of the mixing part 100 and moves the second groove part 120 or the second channel 112b through the microchannel 101 and thus is uniformly supplied to the hydrogen separation membrane 10.

In the hydrogen separation membrane module 2 according to the second exemplary embodiment of the present invention, as illustrated in FIG. 12, the mixture air supplied to the supply pipe 211 is uniformly supplied to the hydrogen separation membrane 230 through the mixing part 220 and the hydrogen purified by the hydrogen separation membrane 230 is supplied to the inner space of the support 240 which is a porous body and is finally discharged along the opened both ends or opened one end of the support 240.

The present invention should not be construed to being limited to the above-mentioned exemplary embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

1. A hydrogen separation membrane module having a mixing part, comprising:
a housing having a hydrogen separation space disposed therein;
a supply part communicating with one surface of the hydrogen separation space;
a discharge part communicating with the other surface of the hydrogen separation space;
a hydrogen separation membrane disposed between the supply part and the discharge part in the hydrogen separation space; and
a mixing part having at least one microchannel disposed therein and disposed between the supply part and the hydrogen separation membrane.

2. The hydrogen separation membrane module of claim 1, wherein the mixture part includes first groove parts disposed on an upper surface thereof to be depressed at a predetermined interval along a length direction and second groove parts disposed on a lower surface thereof to be depressed at a predetermined interval along a length direction, and the first groove part and the second groove part are formed to have a predetermined angle and overlapping portions between the first groove parts and the second groove parts penetrate through each other to form a microchannel.

3. The hydrogen separation membrane module of claim 1, wherein the mixture part includes:
a first membrane provided with a plurality of first bars, being spaced apart from each other at a predetermined distance; and
a second membrane disposed under the first membrane and provided with a plurality of second bars, being spaced apart from each other at a predetermined distance, the second bars being coupled or integrally formed having a predetermined slope with respect to the first bar, and the microchannel is formed in a spaced space between the first bar and the second bar.

4. The hydrogen separation membrane module of claim 1, wherein the mixture part is made of ceramic or a metal material which is not alloyed with the hydrogen separation membrane.

5. The hydrogen separation membrane module of claim 4, wherein an outer surface of the mixing part is provided with an oxide layer.

6. The hydrogen separation membrane module of claim 5, wherein when the mixing part is made of the metal material, the oxide layer is formed by coating the mixing part with any one selected from aluminum (Al), zirconium (Zr), silicon (Si), and titanium (Ti) oxides.

7. The hydrogen separation membrane module of claim 5, wherein when the mixing part is made of the aluminum material, the oxide layer is formed by oxidizing the mixing part.

8. The hydrogen separation membrane module of claim 1, wherein an internal seal is densely disposed between the hydrogen separation membrane and the housing and a diffusion suppression layer is disposed between the hydrogen separation membrane and the internal seal.

9. The hydrogen separation membrane module of claim 1, wherein an internal seal is densely disposed between the hydrogen separation membrane and the housing and an outer surface of the internal seal is provided with a real diffusion suppression layer configured to enclose the internal seal.

10. The hydrogen separation membrane module of claim 1, wherein the housing, the mixing part, and the hydrogen separation membrane are a tube type in which both ends are opened and an inside of the housing is sequentially stacked with the mixing part and the hydrogen separation membrane.
